(19) United States
(12) Patent Application Publication
(10) Pub. No.: US 2026/0290202 A1
(43) Pub. Date: Sep. 24, 2026

(54) MONITORING AND IMPROVING THE DRIVING BEHAVIOR OF TEEN DRIVERS

(71) Applicant: Texas State University, San Marcos, TX (US)

(72) Inventors: Anandi K. Dutta, San Marcos, TX (US); Anannya Ghosh Tusti, San Marcos, TX (US); Subasish Das, San Marcos, TX (US)

(21) Appl. No.: 19/574,902

(22) Filed: Mar. 23, 2026

Related U.S. Application Data
(60) Provisional application No. 63/776,074, filed on Mar. 22, 2025.

(51) Int. Cl. G09B 19/16; B60W 40/09; B60W 50/14; G08B 21/02

(52) U.S. Cl. CPC G09B 19/167; B60W 40/09; B60W 50/14; G08B 21/0205

(57) ABSTRACT

A computer-implemented method, computing device, and computer program product for improving teen driver behavior. A plurality of driving parameters associated with a teen driver are monitored during a driving session via a computing device. An artificial intelligence (AI) engine analyzes the driving parameters to identify a driving risk. The identified driving risk is classified into one of a plurality of risk categories. Based on the classified driving risk, a real-time corrective feedback notification is generated and conveyed to the teen driver via an interface of the computing device to mitigate the driving risk. The driving parameters are synchronized with a cloud-based server to update an adaptive learning model and a mastery score representing driver proficiency. The adaptive learning model identifies personalized training modules for the driver, facilitating a transition from immediate risk mitigation to consistent safe-driving habits through iterative feedback and skill reinforcement.

### TECHNICAL FIELD

The present disclosure relates generally to vehicle safety systems, and more particularly to a road safety application and system for monitoring and improving the driving behavior of teen drivers through real-time feedback and data analytics.

### BACKGROUND

Vehicle safety systems have evolved significantly, moving from passive safety features, such as seatbelts and airbags, to active safety technologies designed to prevent accidents before they occur. Modern automotive safety often incorporates Advanced Driver Assistance Systems (ADAS) that utilize sensors, cameras, and onboard diagnostics to monitor the vehicle's environment. While these systems have improved general road safety by providing features, such as lane-departure warnings and automatic emergency braking, they are often designed for a general driving population and may not address the specific behavioral and developmental challenges associated with novice or adolescent operators.

Teen driving safety remains a critical public concern, as young drivers, particularly those between the ages of 14 and 18, are disproportionately involved in traffic incidents. This increased risk is often attributed to a combination of inexperience, risk-taking behavior, and frequent distractions. Studies indicate that novice drivers are notably more prone to dangerous behaviors, such as phone distraction, speeding, and impaired decision-making, all of which significantly contribute to the rate of road crashes.

Traditional driver education programs often fail to provide the real-time corrective feedback necessary to influence these risky behaviors effectively. Evaluations of such programs have shown mixed results, often yielding only moderate improvements in knowledge or short-term crash reductions without addressing long-term behavioral changes. Research suggests that novice drivers benefit more significantly from continuous, interactive learning interventions and behavior monitoring rather than one-time instructional courses.

While recent advances in mobile sensing, telematics, and artificial intelligence (AI) have enabled the real-time tracking of driver behaviors, many existing technological models remain limited in their ability to provide personalized, adaptive engagement. There is a growing demand for intelligent training systems that integrate AI-driven behavioral analysis with personalized feedback to offer customized corrective strategies.

Consequently, there is a need for a comprehensive safety application that integrates interactive learning, behavior tracking, and real-time data analytics to engage young drivers. Such a system would ideally utilize a multi-layered approach to identify and mitigate unsafe driving conditions while providing actionable insights to parents and other stakeholders to foster a long-term culture of road safety.

### SUMMARY

In one embodiment of the present disclosure, a computer-implemented method for monitoring and improving driving behavior of a teen driver comprises monitoring, via a computing device, a plurality of driving parameters associated with the teen driver during a driving session. The method further comprises analyzing the plurality of driving parameters using an artificial intelligence (AI) engine to identify a driving risk. The method additionally comprises classifying the driving risk into one of a plurality of risk categories. Furthermore, the method comprises generating a real-time corrective feedback notification based on the classified driving risk. Additionally, the method comprises conveying the real-time corrective feedback notification to the teen driver via an interface of the computing device to mitigate the driving risk.

Other forms of the embodiment of the computer-implemented method described above are in a computing device and in a computer program product.

The foregoing has outlined rather generally the features and technical advantages of one or more embodiments of the present disclosure in order that the detailed description of the present disclosure that follows may be better understood. Additional features and advantages of the present disclosure will be described hereinafter which may form the subject of the claims of the present disclosure.

### BRIEF DESCRIPTION OF THE DRAWINGS

A better understanding of the present disclosure can be obtained when the following detailed description is considered in conjunction with the following drawings, in which:

FIG. 1 illustrates an embodiment of the present disclosure of a computing environment for practicing the principles of the present disclosure;

FIG. 2 is a diagram of the software components used by the computer to monitor and improve the driving behavior of teen drivers through real-time feedback and data analytics in accordance with an embodiment of the present disclosure;

FIG. 3 is a flowchart of a method for monitoring and improving the driving behavior of teen drivers through real-time feedback and data analytics in accordance with an embodiment of the present disclosure;

FIG. 4 is a flowchart of a method for implementing an adaptive safety alert in accordance with an embodiment of the present disclosure; and

FIG. 5 is a diagram of the simulation and PC/tablet-based programs in accordance with an embodiment of the present disclosure.

### DETAILED DESCRIPTION

As stated above, teen driving safety remains a critical public concern, as young drivers, particularly those between the ages of 14 and 18, are disproportionately involved in traffic incidents. This increased risk is often attributed to a combination of inexperience, risk-taking behavior, and frequent distractions. Studies indicate that novice drivers are notably more prone to dangerous behaviors, such as phone distraction, speeding, and impaired decision-making, all of which significantly contribute to the rate of road crashes.

Traditional driver education programs often fail to provide the real-time corrective feedback necessary to influence these risky behaviors effectively. Evaluations of such programs have shown mixed results, often yielding only moderate improvements in knowledge or short-term crash reductions without addressing long-term behavioral changes. Research suggests that novice drivers benefit more significantly from continuous, interactive learning interventions and behavior monitoring rather than one-time instructional courses.

While recent advances in mobile sensing, telematics, and artificial intelligence (AI) have enabled the real-time tracking of driver behaviors, many existing technological models remain limited in their ability to provide personalized, adaptive engagement. There is a growing demand for intelligent training systems that integrate AI-driven behavioral analysis with personalized feedback to offer customized corrective strategies.

Consequently, there is a need for a comprehensive safety application that integrates interactive learning, behavior tracking, and real-time data analytics to engage young drivers. Such a system would ideally utilize a multi-layered approach to identify and mitigate unsafe driving conditions while providing actionable insights to parents and other stakeholders to foster a long-term culture of road safety.

The embodiments of the present disclosure provide a means for monitoring and improving the driving behavior of a teen driver through an integrated, AI-driven safety ecosystem. Specifically, the present disclosure utilizes a computing device to monitor a plurality of driving parameters, such as vehicle speed, braking intensity, turn aggression, and device-based distraction indicators, during a driving session. An artificial intelligence (AI) engine analyzes these parameters in real-time to identify and classify driving risks into specific categories. Upon detection of a risk, the system generates and conveys real-time corrective feedback notifications, including haptic, audio, or visual alerts, directly to the teen driver to facilitate immediate mitigation.

Furthermore, the system provides a multi-layered oversight mechanism by transmitting parental alerts to a guardian's secondary device and implementing geo-fencing technology to monitor vehicle proximity to restricted zones. By synchronizing captured driving data with a cloud-based server, the system continuously updates an adaptive learning model tailored to the specific behavioral patterns of the driver. In this manner, the embodiments of the present disclosure transition driver education from static instruction to a dynamic, interactive mastery process that fosters long-term road safety. A further discussion regarding these and other features is provided below.

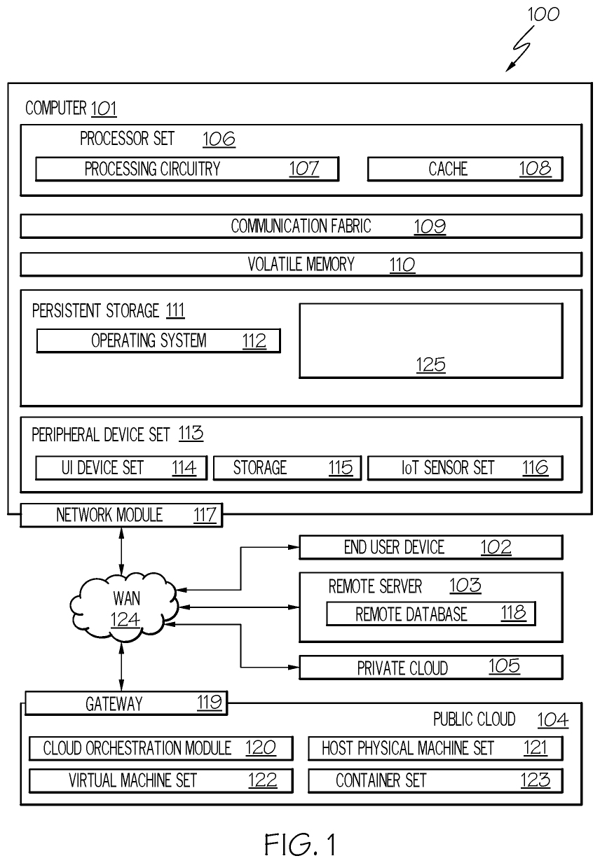

Referring now to the Figures in detail, FIG. 1 illustrates an embodiment of the present disclosure of a computing environment 100 for practicing the principles of the present disclosure.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code (stored in block 125) involved in performing the inventive methods, such as monitoring and improving the driving behavior of teen drivers through real-time feedback and data analytics. In addition to block 125, computing environment 100 includes, for example, computer 101 (also referred to herein as computing device 101), network 124, such as a wide area network (WAN), end user device (EUD) 102, remote server 103, public cloud 104, and private cloud 105. In this embodiment, computer 101 includes processor set 106 (including processing circuitry 107 and cache 108), communication fabric 109, volatile memory 110, persistent storage 111 (including operating system 112 and block 125, as identified above), peripheral device set 113 (including user interface (UI) device set 114, storage 115, and Internet of Things (IoT) sensor set 116), and network module 117. Remote server 103 includes remote database 118. Public cloud 104 includes gateway 119, cloud orchestration module 120, host physical machine set 121, virtual machine set 122, and container set 123.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 118. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 106 includes one, or more, computer processors of any type now known or to be developed in the future. Processing circuitry 107 may be distributed over multiple packages, for example, multiple, coordinated integrated circuit chips. Processing circuitry 107 may implement multiple processor threads and/or multiple processor cores. Cache 108 is memory that is located in the processor chip package(s) and is typically used for data or code that should be available for rapid access by the threads or cores running on processor set 106. Cache memories are typically organized into multiple levels depending upon relative proximity to the processing circuitry. Alternatively, some, or all, of the cache for the processor set may be located “off chip.” In some computing environments, processor set 106 may be designed for working with qubits and performing quantum computing.

Computer readable program instructions are typically loaded onto computer 101 to cause a series of operational steps to be performed by processor set 106 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 108 and the other storage media discussed below. The program instructions, and associated data, are accessed by processor set 106 to control and direct performance of the inventive methods. In computing environment 100, at least some of the instructions for performing the inventive methods may be stored in block 125 in persistent storage 111.

Communication fabric 109 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 110 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 110 is located in a single package and is internal to computer 101, but, alternatively or additionally, the volatile memory may be distributed over multiple packages and/or located externally with respect to computer 101.

Persistent Storage 111 is any form of non-volatile storage for computers that is now known or to be developed in the future. The non-volatility of this storage means that the stored data is maintained regardless of whether power is being supplied to computer 101 and/or directly to persistent storage 111. Persistent storage 111 may be a read only memory (ROM), but typically at least a portion of the persistent storage allows writing of data, deletion of data and re-writing of data. Some familiar forms of persistent storage include magnetic disks and solid state storage devices. Operating system 112 may take several forms, such as various known proprietary operating systems or open source Portable Operating System Interface type operating systems that employ a kernel. The code included in block 125 typically includes at least some of the computer code involved in performing the inventive methods.

Peripheral device set 113 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 114 may include components such as a display screen, speaker, microphone, wearable devices (such as goggles and smart watches), keyboard, mouse, printer, touchpad, game controllers, and haptic devices. Storage 115 is external storage, such as an external hard drive, or insertable storage, such as an SD card. Storage 115 may be persistent and/or volatile. In some embodiments, storage 115 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 116 is made up of sensors that can be used in Internet of Things applications. For example, one sensor may be a thermometer and another sensor may be a motion detector.

Network module 117 is the collection of computer software, hardware, and firmware that allows computer 101 to communicate with other computers through WAN 124. Network module 117 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 117 are performed on the same physical hardware device. In other embodiments (for example, embodiments that utilize software-defined networking (SDN)), the control functions and the forwarding functions of network module 117 are performed on physically separate devices, such that the control functions manage several different network hardware devices. Computer readable program instructions for performing the inventive methods can typically be downloaded to computer 101 from an external computer or external storage device through a network adapter card or network interface included in network module 117.

WAN 124 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 102 is any computer system that is used and controlled by an end user (for example, a customer of an enterprise that operates computer 101), and may take any of the forms discussed above in connection with computer 101. EUD 102 typically receives helpful and useful data from the operations of computer 101. For example, in a hypothetical case where computer 101 is designed to provide a recommendation to an end user, this recommendation would typically be communicated from network module 117 of computer 101 through WAN 124 to EUD 102. In this way, EUD 102 can display, or otherwise present, the recommendation to an end user. In some embodiments, EUD 102 may be a client device, such as thin client, heavy client, mainframe computer, desktop computer and so on.

Remote server 103 is any computer system that serves at least some data and/or functionality to computer 101. Remote server 103 may be controlled and used by the same entity that operates computer 101. Remote server 103 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 118 of remote server 103.

Public cloud 104 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 104 is performed by the computer hardware and/or software of cloud orchestration module 120. The computing resources provided by public cloud 104 are typically implemented by virtual computing environments that run on various computers making up the computers of host physical machine set 121, which is the universe of physical computers in and/or available to public cloud 104. The virtual computing environments (VCEs) typically take the form of virtual machines from virtual machine set 122 and/or containers from container set 123. It is understood that these VCEs may be stored as images and may be transferred among and between the various physical machine hosts, either as images or after instantiation of the VCE. Cloud orchestration module 120 manages the transfer and storage of images, deploys new instantiations of VCEs and manages active instantiations of VCE deployments. Gateway 119 is the collection of computer software, hardware, and firmware that allows public cloud 104 to communicate through WAN 124.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 105 is similar to public cloud 104, except that the computing resources are only available for use by a single enterprise. While private cloud 105 is depicted as being in communication with WAN 124 in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 104 and private cloud 105 are both part of a larger hybrid cloud.

Block 125 further includes the software components which are used to monitor and improve the driving behavior of teen drivers through real-time feedback and data analytics. In one embodiment, such components may be implemented in hardware. The functions discussed above performed by such components are not generic computer functions. As a result, computer 101 is a particular machine that is the result of implementing specific, non-generic computer functions.

In one embodiment, the functionality of such software components of computer 101, including the functionality for monitoring and improving the driving behavior of teen drivers through real-time feedback and data analytics, may be embodied in an application specific integrated circuit.

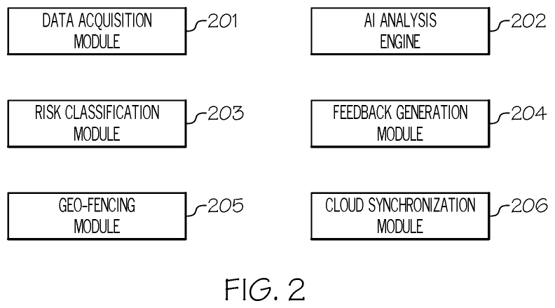

A further discussion regarding the functionality of the components used by computer 101 to monitor and improve the driving behavior of teen drivers through real-time feedback and data analytics is provided below in connection with FIG. 2.

FIG. 2 is a diagram of the software components used by computer 101 to monitor and improve the driving behavior of teen drivers through real-time feedback and data analytics in accordance with an embodiment of the present disclosure.

Referring to FIG. 2, in conjunction with FIG. 1, computer 101 includes data acquisition module 201. In one embodiment, data acquisition module 201 is configured to interface with various sensors and data sources to gather real-time information relevant to the driving environment and the behavior of the teen driver. For example, data acquisition module 201 may collect telemetry data from an onboard diagnostic (OBD) system, location data from a global positioning system (GPS) receiver, and inertial data from accelerometers and gyroscopes. In one embodiment, data acquisition module 201 is configured to interface with edge computing units (ECUs) and vehicle-to-everything (V2X) communication protocols to synchronize engine-level data with mobile sensor data

Additionally, in one embodiment, data acquisition module 201 monitors device-level interactions to identify potential distractions, such as active screen time or application usage during a driving session. The data gathered by data acquisition module 201 serves as the primary input for the system, providing a continuous stream of raw parameters that are subsequently processed to identify driving risks. The specific methodologies for triggering data collection and the types of parameters monitored are discussed in greater detail below in connection with the discussion of the flowcharts.

Computer 101 further includes AI analysis engine 202. AI analysis engine 202 is configured to receive the stream of raw driving parameters from data acquisition module 201 and process the parameters to identify driving risks and behavioral patterns. In some embodiments, AI analysis engine 202 utilizes one or more machine learning models, such as neural networks, decision trees, or random forest algorithms, to perform real-time behavioral analysis. By evaluating the relationship between various inputs (e.g., comparing vehicle speed against local speed limit data or correlating accelerometer spikes with GPS-derived turn radius), AI analysis engine 202 can distinguish between standard driving maneuvers and high-risk behaviors.

Furthermore, in one embodiment, AI analysis engine 202 incorporates an adaptive learning component that adjusts its analysis based on the historical data of a specific driver, thereby tailoring the risk identification process to the driver's developmental progress. In one embodiment, AI analysis engine 202 transforms raw sensor inputs into actionable safety insights, which are then utilized by subsequent modules to categorize risks and trigger appropriate interventions. The specific logic for identifying and weighting these driving risks is discussed in greater detail below in connection with the discussion of the flowcharts.

Computer 101 additionally includes risk classification module 203. Risk classification module 203 is configured to receive the actionable safety insights and identified behavioral patterns from AI analysis engine 202 and categorize them into one or more risk levels or categories. In one embodiment, risk classification module 203 utilizes a rule-based logic or a scoring heuristic to determine the severity of a detected driving event. For example, risk classification module 203 may classify an event as “low,” “moderate,” or “high” risk based on the degree to which a driving parameter deviates from a safety threshold, such as the magnitude of a speeding violation or the intensity of a hard-braking event.

Furthermore, in one embodiment, risk classification module 203 is configured to prioritize concurrent risks, ensuring that the most critical safety threats are addressed first. In one embodiment, risk classification module 203 maps these classified risks to specific response protocols, which are then utilized by subsequent modules to determine the appropriate type and intensity of feedback to be delivered. This classification process allows the system to distinguish between minor technical errors and dangerous behavioral trends, providing a structured foundation for targeted driver intervention. The specific categories and thresholds used for risk classification are discussed in greater detail below in connection with the discussion of the flowcharts.

Furthermore, computer 101 includes feedback generation module 204. Feedback generation module 204 is configured to receive the categorized risk levels from risk classification module 203 and determine the appropriate corrective response to be delivered to the teen driver. In one embodiment, feedback generation module 204 translates the abstract risk classification into a specific set of hardware-level commands to trigger real-time notifications. These notifications may include, but are not limited to, haptic alerts (e.g., vibrations through a mobile device or wearable), audio cues (e.g., spoken warnings or alert tones), and visual indicators (e.g., graphical overlays or color-coded warnings on a user interface).

Additionally, in one embodiment, feedback generation module 204 is configured to implement a multi-layered warning system where the intensity or type of feedback scales with the severity of the identified risk. For example, a low-risk speeding event may trigger a subtle visual reminder, whereas, a high-risk distracted driving event may trigger a combination of audio and haptic alerts to ensure immediate driver redirection. In some embodiments, feedback generation module 204 also manages the transmission of external notifications, such as parental alerts, to secondary devices associated with a guardian. The specific timing and delivery protocols for these feedback mechanisms are discussed in greater detail below in connection with the discussion of the flowcharts.

Additionally, computer 101 includes geo-fencing module 205 configured to monitor the geographical location of the computing device (e.g., computer 101) in relation to one or more predefined restricted zones. In one embodiment, geo-fencing module 205 interfaces with a global positioning system (GPS) receiver or other location-based services to determine real-time coordinates of the vehicle. These coordinates are compared against a set of boundary parameters, which may be established by a guardian or a third-party safety database, representing areas where driving is restricted, discouraged, or requires heightened caution.

When geo-fencing module 205 determines that the computing device monitored via geo-fencing technology has entered, exited, or is approaching a predefined restricted zone, it is configured to trigger an adaptive safety alert. A predefined restricted zone, as used herein, is a geographically delimited area, monitored via geo-fencing technology, that triggers adaptive safety alerts on a computing device when a vehicle enters its boundaries to mitigate potential driving risks. These alerts may be processed by feedback generation module 204 to provide immediate notification to the teen driver, and may further include transmitting a status update to a secondary device associated with a guardian. By integrating spatial awareness into the safety ecosystem, geo-fencing module 205 allows the system to provide context-specific safety interventions based on the vehicle's physical environment. The specific logic for establishing these zones and the corresponding alert protocols are discussed in greater detail below in connection with the discussion of the flowcharts.

Computer 101 additionally includes cloud synchronization module 206. Cloud synchronization module 206 is configured to facilitate the exchange of data between computer 101 and a remote storage or processing environment, such as a cloud-based server. In one embodiment, cloud synchronization module 206 manages the transmission of captured driving parameters, identified risk events, and calculated safety scores to the cloud-based server for long-term storage and aggregate analysis. This synchronization may occur in real-time, periodically, or upon the conclusion of a driving session, depending on network availability and system configuration.

Furthermore, cloud synchronization module 206 is configured to receive updates from the cloud-based server to refine the local operation of the system. For example, cloud synchronization module 206 may download updated machine learning weights, new speed limit databases, or adjusted geo-fencing boundaries. In one embodiment, cloud synchronization module 206 plays a role in the adaptive learning process by providing the necessary data to update the driver's behavioral profile on the server, which is then fed back to AI analysis engine 202 to improve future risk identification. By maintaining a persistent link with remote infrastructure, cloud synchronization module 206 ensures that the safety application remains current with emerging driving trends and personalized driver progress. The specific protocols for data transmission and model updates are discussed in greater detail below in connection with the discussion of the flowcharts.

In one embodiment, cloud synchronization module 206 implements encryption and anonymization protocols to safeguard collected driving parameters in compliance with GDPR and ISO/IEC 27001:2013 standards

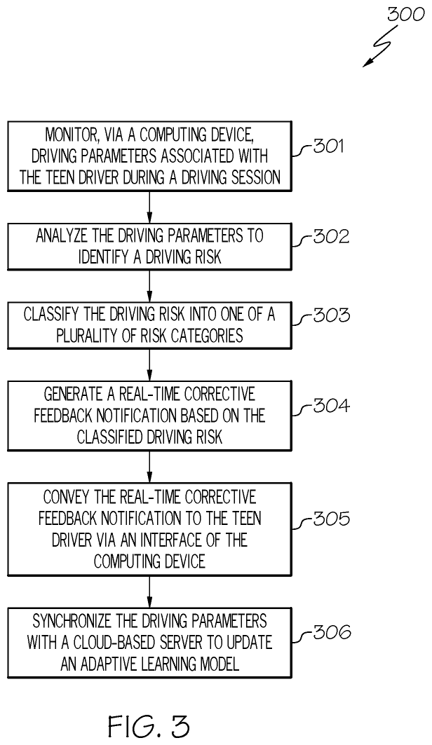

A discussion regarding the method for monitoring and improving the driving behavior of teen drivers through real-time feedback and data analytics using the software components discussed above is provided below in connection with FIG. 3.

FIG. 3 is a flowchart of a method 300 for monitoring and improving the driving behavior of teen drivers through real-time feedback and data analytics in accordance with an embodiment of the present disclosure.

Referring now to FIG. 3, in conjunction with FIGS. 1-2, in step 301, data acquisition module 201 monitors, via a computing device (e.g., computer 101), driving parameters associated with the teen driver during a driving session. Driving parameters, as used herein, refers to a collection of data points captured by internal or external sensors of the computing device that characterize the movement of the vehicle and the behavior of the operator. Examples of driving parameters include, but are not limited to, vehicle speed, braking intensity, turn aggression, and device-based distraction indicators.

In one embodiment, data acquisition module 201 monitors driving parameters through the integration of the computing device (e.g., computer 101) with the vehicle's communication bus, such as an On-Board Diagnostics (OBD-II) port, utilizing wireless protocols, such as Bluetooth® or Wi-Fi®, to capture engine-level data including vehicle speed, revolutions per minute (RPM), and throttle position. Simultaneously, data acquisition module 201 leverages the internal sensor suite of computer 101, specifically high-frequency polling of the three-axis accelerometer and gyroscope, to measure linear and angular acceleration. This allows the system to identify physical maneuvers, such as hard braking, rapid acceleration, and aggressive cornering.

Furthermore, to identify potential “phone distraction” parameters, data acquisition module 201 may interface with the operating system of computer 101 to monitor device-state events, such as screen-on latency, application foregrounding, or handheld movement patterns detected via the inertial sensors while the vehicle is in motion. In one embodiment, to enable spatial monitoring, a global positioning system (GPS) receiver provides a continuous stream of coordinate data, which is sampled at regular intervals (e.g., 1 Hz or higher) to determine the vehicle's heading, velocity, and proximity to known road features or restricted zones. In one embodiment, the system utilizes 5G and LTE connectivity for ultra-low latency (near-instantaneous) transmission of critical safety alerts and Bluetooth Low Energy (BLE) for proximity-based data transfer between the device and the vehicle. These disparate data streams are synchronized by data acquisition module 201 to create a comprehensive time-series dataset of the driving session, which serves as the technical foundation for the subsequent AI-driven analysis.

In step 302, AI analysis engine 202 analyzes the driving parameters using an AI engine to identify a driving risk. A driving risk, as used herein, refers to any detected behavior or vehicular state that deviates from established safety profiles or regulatory requirements, such as excessive speed, aggressive maneuvering, or operator distraction. In one embodiment, the identification of the driving risk is performed at least in part by an Edge Computing Unit (ECU) in wireless communication with the computing device (e.g., computer 101).

In one embodiment, AI analysis engine 202 analyzes the driving parameters using an AI engine to identify a driving risk by feeding the synchronized time-series data from data acquisition module 201 into a pre-trained machine learning model hosted locally on computer 101. To enable real-time risk identification, AI analysis engine 202 performs feature extraction on the raw sensor data (e.g., calculating the “jerk” (the rate of change of acceleration) to distinguish between a standard stop and a high-risk “hard braking” event). Simultaneously, AI analysis engine 202 correlates GPS-derived velocity against a local or cloud-based geospatial database of speed limits to identify “speeding” risks. In one embodiment, AI analysis engine 202 utilizes graph-based neural networks (GNNs) and probabilistic heuristic models to analyze synchronized time-series sensor data and identify latent hazards.

Furthermore, to identify “distracted driving” risks, AI analysis engine 202 may utilize a heuristic or probabilistic model that evaluates the frequency and duration of device-level events (e.g., screen-on state) in conjunction with vehicle motion. If the vehicle is traveling above a minimum threshold (e.g., 5 mph) and the device is being actively handled or the screen is active, then AI analysis engine 202 flags the event as a risk. To enable “adaptive learning,” AI analysis engine 202 may also compare current maneuvers against the driver's historical baseline to determine if a specific behavior is an anomaly or a recurring trend. This analytical process transforms disparate sensor inputs into a discrete set of identified risks that are passed to the classification module for further processing.

In step 303, risk classification module 203 classifies the driving risk into one of a plurality of risk categories. A driving risk, as used herein, refers to any identified behavior or vehicular event, such as those detected in step 302, that represents a deviation from safe driving standards. A risk category, as used herein, refers to a discrete classification level assigned to a driving risk based on its potential severity, frequency, or impact on road safety. In one embodiment, the classification process serves as the technical bridge to the “mitigation” phase of the 3M protocol, where the system determines the severity of the mistake to select an appropriate intervention. The 3M protocol (mistake, mitigation, and mastery), as used herein, is an interactive, error-based learning approach that utilizes real-time feedback to improve driver learning retention by transitioning from the immediate mitigation of driving risks to the development of consistent, long-term safe-driving habits. The mistake of the 3M protocol, as used herein, refers to identifying and monitoring real-time driving errors or risky behaviors, such as speeding or distractions, via a computing device (e.g., computer 101). The mitigation of the 3M protocol, as used herein, refers to generating immediate corrective feedback, such as haptic, audio, or visual alerts, to help the driver address and neutralize identified risks as they occur. The mastery of the 3M protocol, as used herein, refers to using an adaptive AI learning model to provide personalized training modules and skill reinforcement, facilitating the transition from one-time corrections to a state of sustained driver proficiency.

In one embodiment, risk classification module 203 classifies the driving risk into one of a plurality of risk categories by applying a hierarchical scoring logic to the identified risks. In one embodiment, risk classification module 203 evaluates the output of AI analysis engine 202 against a set of predefined safety benchmarks stored in a local or cloud-based database. In one embodiment, these categories include, but are not limited to, “low risk” (e.g., minor speed fluctuations), “moderate risk” (e.g., occasional hard braking), and “high risk” (e.g., active phone distraction or significant speeding). In one embodiment, risk classification module 203 utilizes a multi-factor weighting system that considers environmental context. For example, a speeding event in a school zone may be automatically escalated to a higher risk category than the same speed recorded on a highway.

In one embodiment, risk classification module 203 classifies the driving risk into one of a plurality of risk categories by a state-machine that tracks the persistence of a behavior. If a specific driving risk is detected repeatedly within a single driving session, risk classification module 203 may transition the classification from a “cautionary” category to a “critical” category. In one embodiment, the relationship between specific behavioral triggers and their corresponding risk classifications are mapped and stored in a data structure. This classification provides the granular data necessary for the system to generate proportional feedback, ensuring that the driver is alerted with an intensity that matches the danger of the situation.

In step 304, feedback generation module 204 generates a real-time corrective feedback notification based on the classified driving risk. A real-time corrective feedback notification, as used herein, refers to an electronically generated signal—delivered via haptic, audio, or visual means—intended to alert the teen driver to a specific unsafe behavior and prompt a corrective action. In one embodiment, feedback generation module 204 generates the real-time corrective feedback notification by executing the “mitigation” phase of the protocol by delivering the selected intervention to the driver.

In one embodiment, feedback generation module 204 generates a real-time corrective feedback notification based on the classified driving risk by mapping the risk category determined in step 303 to a specific notification protocol stored in a local configuration file. In one embodiment, feedback generation module 204 triggers a set of application programming interface (API) calls to the operating system of computer 101 to activate the device's output hardware. For example, to generate a haptic alert, feedback generation module 204 invokes a specific vibration pattern (e.g., a “double-pulse” for speeding or a “continuous rumble” for lane departure) through the device's linear resonant actuator (LRA). In one embodiment, the selection of the notification type is directly proportional to the severity of the risk; for instance, “high risk” events may trigger a synchronized combination of audio warnings and haptic pulses to ensure the driver's attention is captured immediately.

Furthermore, to enable visual feedback, feedback generation module 204 may generate a graphical overlay on the display of computer 101, such as a color-coded warning (e.g., a red flashing border for critical risks) or a text-based instruction (e.g., “reduce speed”). To minimize further distraction, these visual alerts may be configured to disappear automatically once the sensors in data acquisition module 201 confirm that the driving parameters have returned to a safe threshold. This closed-loop generation process ensures that the feedback is not only immediate but also contextually relevant to the specific “mistake” being mitigated, thereby facilitating the “mastery” phase of the driver's development. As previously discussed, the mastery phase of the driver's development refers to the long-term behavioral transformation achieved through continuous AI-driven monitoring and iterative, personalized feedback that transitions a novice driver from immediate risk mitigation to consistent safe-driving habits.

In step 305, geo-fencing module 205 conveys the real-time corrective feedback notification to the teen driver via an interface of the computing device (e.g., computer 101). In one embodiment, geo-fencing module 205 conveys the real-time corrective feedback notification to the teen driver by geo-fencing module 205 acting as a secondary trigger for feedback generation module 204. When geo-fencing module 205 determines that the vehicle's current GPS coordinates intersect with a predefined restricted zone, it generates an interrupt signal that overrides or supplements standard driving parameter monitoring.

In one embodiment, the system utilizes the user interface (UI) layer of the computing device (e.g., computer 101) to present adaptive safety alerts. In one embodiment, geo-fencing module 205 utilizes a spatial-query engine that compares real-time telemetry data against a locally cached geofence database (e.g., a “point-in-polygon” algorithm). If a violation is detected, then geo-fencing module 205 triggers the conveyance of specific feedback, such as a “restricted area” audio chime or a haptic pulse, through the hardware outputs described in step 304.

Furthermore, in one embodiment, geo-fencing module 205 conveys the real-time corrective feedback notification to the teen driver by a network-conveyance protocol where, upon the detection of a geo-fencing event, geo-fencing module 205 initiates a secure transmission (e.g., via Hypertext Transfer Protocol Secure (HTTPS) or Message Queuing Telemetry Transport (MQTT)) to a secondary device associated with a guardian. In one embodiment, the system maps specific geo-fenced zones to different notification intensities. For example, entering a “high-risk/no-drive” zone may trigger a persistent notification until the vehicle exits the boundary. This multi-channel conveyance ensures that the feedback is not only delivered to the driver but also logged for parental oversight, facilitating the collaborative “mastery” phase of the driver education process.

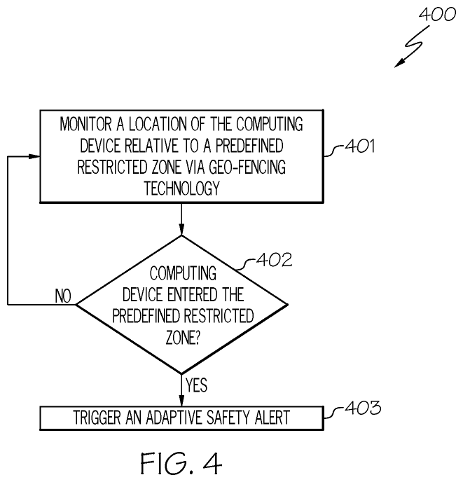

The specific implementation of the geo-fencing and adaptive safety alert logic mentioned in step 305 is further illustrated in the flowchart of FIG. 4.

FIG. 4 is a flowchart of a method 400 for implementing an adaptive safety alert in accordance with an embodiment of the present disclosure.

Referring to FIG. 4, in conjunction with FIGS. 1-3, in step 401, data acquisition module 201 monitors a location of the computing device (e.g., computer 101) relative to a predefined restricted zone via geo-fencing technology. A predefined restricted zone, as used herein, refers to a geographically bounded area—defined by a set of coordinates, a radius around a point of interest, or a polygonal boundary—within which specific driving behaviors are monitored or restricted.

In one embodiment, data acquisition module 201 monitors a location of the computing device (e.g., computer 101) relative to a predefined restricted zone via geo-fencing technology by continuously polling the GPS receiver of computer 101 to obtain real-time telemetry data, including latitude, longitude, and horizontal accuracy. To implement the geo-fencing monitoring, geo-fencing module 205 performs a spatial comparison between these real-time coordinates and a locally cached database of restricted zones. This comparison may utilize a point-in-polygon (PIP) algorithm or a circular proximity check to determine if the vehicle is approaching, has entered, or is remaining within the predefined restricted zone. By sampling the location at a frequency sufficient to capture vehicle movement (e.g., 1 Hz), the system ensures that the adaptive safety alert logic is triggered with minimal latency upon the vehicle crossing a virtual boundary.

In step 402, geo-fencing module 205 determines if the computing device (e.g., computer 101) has entered the predefined restricted zone. In one embodiment, geo-fencing module 205 determines if the computing device (e.g., computer 101) has entered the predefined restricted zone by a logical comparison between the real-time coordinate data acquired in step 401 and the spatial boundaries of the predefined restricted zone stored in a local or cloud-based database.

In one embodiment, geo-fencing module 205 executes a geometric intersection test, such as a “Point-in-Polygon” (PIP) algorithm or a radial distance check, against a central waypoint to make such a determination of zone entry. For example, geo-fencing module 205 may calculate the Euclidean distance between the current GPS coordinates of computer 101 and the center of a circular restricted zone. If the distance is less than a predefined radius (e.g., 500 feet), then geo-fencing module 205 identifies a “zone entry” event. Alternatively, for complex boundaries, such as school zones or city limits, geo-fencing module 205 may utilize a ray-casting algorithm to determine if the device's coordinates fall within the vertices of a polygonal geofence.

Furthermore, in one embodiment, geo-fencing module 205 determines if the computing device (e.g., computer 101) has entered the predefined restricted zone by the generation of a state-change interrupt. When geo-fencing module 205 detects that the status of the computing device (e.g., computer 101) has transitioned from “outside” to “inside” the restricted zone, it flags the event as an “active geofence state.” This state-change ensures that the adaptive safety alert remains active and continues to monitor driver behavior with increased sensitivity for the duration of the vehicle's presence within the restricted zone boundary.

If the computing device (e.g., computer 101) has not entered the predefined restricted zone, then data acquisition module 201 continues to monitor a location of the computing device (e.g., computer 101) relative to a predefined restricted zone via geo-fencing technology in step 401.

If, however, the computing device (e.g., computer 101) has entered the predefined restricted zone, then, in step 403, geo-fencing module 205 triggers an adaptive safety alert. An adaptive safety alert, as used herein, refers to a dynamic notification whose delivery parameters. including modality, intensity, and frequency, are automatically modified by the system to correspond with the unique safety requirements of the entered restricted zone. In one embodiment, geo-fencing module 205 triggers an adaptive safety alert by transmitting a “zone entry” payload to feedback generation module 204. A zone entry payload, as used herein, is a structured data packet transmitted from geo-fencing module 205 to feedback generation module 204 that contains the specific geographic identifier and metadata required to trigger a context-aware notification upon entering a restricted boundary. This payload contains instructions to override the standard baseline notification settings with “high-sensitivity” or “zone-specific” alert profiles. A high-sensitivity alert profile, as used herein, is a software configuration that lowers the risk-detection thresholds for specific driving parameters, such as speed or braking intensity, to ensure that even minor deviations from safety standards trigger an immediate corrective notification. A zone-specific alert profile, as used herein, is a customized set of notification parameters, including unique audio chimes, haptic patterns, or visual overlays, that are uniquely mapped to a particular type of geo-fenced area, such as a school zone or a high-traffic intersection.

Returning to FIG. 3, in conjunction with FIGS. 1-2 and 4, in step 306, cloud synchronization module 206 synchronizes the driving parameters with a cloud-based server to update an adaptive learning model. In one embodiment, cloud synchronization module 206 synchronizes the driving parameters with a cloud-based server to update an adaptive learning model by packaging the data into a compressed format (e.g., JSON or XML) and transmitting it via HTTPS or MQTT to a centralized database hosted on the cloud-based server.

In one embodiment, the synchronization of data at step 306 facilitates the “mastery” phase of the 3M protocol by converting raw driving logs into long-term behavioral profiles.

In one embodiment, cloud synchronization module 206 synchronizes the driving parameters with a cloud-based server to update an adaptive learning model by a server-side processing engine that integrates the synchronized driving parameters into a centralized database. The adaptive learning model, as used herein, refers to a dynamic mathematical profile that represents the teen driver's unique behavioral tendencies and developmental progress over time. The synchronization process fits into this model by providing the “ground truth” data required to refine the AI's future analysis. For example, if the synchronized data shows a consistent improvement in a driver's braking patterns, the adaptive learning model updates the driver's profile to reflect a higher “mastery” score, which may subsequently result in adjusted sensitivity thresholds for AI analysis engine 202. A mastery score, as used herein, is a quantitative metric generated by the adaptive learning model that represents a driver's proficiency level by aggregating synchronized driving parameters, risk frequency, and the successful application of corrective feedback over time.

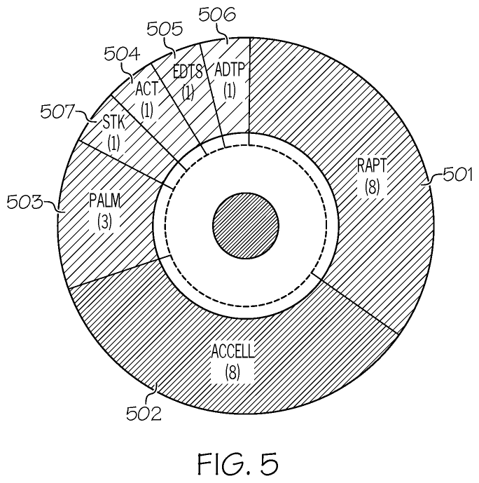

Furthermore, the updated adaptive learning model may be utilized to generate personalized training modules or reports for the guardian, which are then transmitted back to the secondary device. By continuously updating the model through the synchronization of real-world driving data, the system transitions from a static monitoring tool to an evolving educational ecosystem. In one embodiment, the synchronization frequency and the specific parameters transmitted are mapped to the driver's current mastery level, ensuring that the adaptive learning model is consistently fed with the most relevant behavioral data. The resulting personalized curriculum generated by the adaptive learning model is further illustrated in FIG. 5.

FIG. 5 is a diagram of the simulation and PC/tablet-based programs in accordance with an embodiment of the present disclosure.

Referring to FIG. 5, FIG. 5 illustrates the educational architecture utilized during the mastery stage (described conceptually) of the 3M protocol.

In this embodiment, the system translates the mastery score and synchronized driving parameters into a personalized curriculum of training modules designed to reinforce safe driving habits. In one embodiment, the mastery stage translates the mastery score into a personalized curriculum that includes Risk Awareness Perception Training (RAPT) 501, ACCEL 502 (hazard anticipation), and PALM 503 (attention maintenance) modules discussed below.

For example, the training ecosystem includes a plurality of specialized programs, such as Risk Awareness Perception Training (RAPT) 501, ACCEL 502, and PALM 503. In one embodiment, the size of the segments within the concentric circles, or the numerical values associated therewith (e.g., RAPT (8), ACCEL (8), PALM (3)), represent the weighting or frequency of these modules as assigned by the adaptive learning model based on the teen driver's identified risks. For example, the RAPT and ACCEL modules focus on improving hazard anticipation through exposure to dynamic, risk-laden scenarios and real-time feedback, while the PALM module focuses on enhancing hazard perception by teaching drivers to recognize and categorize potential risks quickly and effectively.

Furthermore, FIG. 5 illustrates auxiliary training components including, but not limited to, scenario-based driving simulations (ACT) 504, tablet-based interactive training (EDTS) 505, hands-on vehicle handling (ADTP) 506, and community-based parental engagement programs (STK) 507. These modules are delivered via the interface of computer 101 or a secondary device to provide repeated skill reinforcement in areas, such as hazard mitigation, attention management, and situational awareness. By integrating these diverse training modalities, the system ensures that the “mastery” phase of the driver's development is both data-driven and contextually relevant to the specific mistakes identified during active driving sessions.

In this manner, the principles of the present disclosure described herein provide a technical solution to the long-standing problem of elevated vehicular risk among novice drivers by transforming a standard computing device into a real-time, context-aware coaching ecosystem. Unlike static monitoring tools or traditional driver education, the embodiments of the present disclosure leverage a synchronized integration of engine-level data and high-frequency inertial sensors to move beyond simple event logging. By utilizing the 3M protocol to identify “mistakes” in real-time, the system provides immediate, proportional “mitigation” through adaptive haptic and audio alerts that are contextually mapped to the driver's specific geographic environment. This closed-loop interaction ensures that corrective feedback is delivered exactly when the driver's cognitive load is highest, effectively interrupting unsafe habits before they result in a collision.

Furthermore, the principles of the present disclosure overcome the limitations of “one-size-fits-all” training by utilizing an AI-driven adaptive learning model to bridge the gap between real-world driving and digital skill reinforcement. By synchronizing disparate data streams to generate a quantitative “mastery score,” the system identifies specific cognitive deficits, such as a failure to recognize latent hazards or poor attention management. These insights are then used to dynamically curate a personalized curriculum of simulation and interactive programs, as illustrated in FIG. 5. This iterative process transitions the driver from a state of reactive risk mitigation to a state of proactive situational awareness, facilitating a long-term behavioral transformation that is unattainable through intermittent parental supervision or classroom instruction alone.

Finally, the integration of geo-fencing technology and multi-channel network conveyance ensures a collaborative safety environment that extends beyond the vehicle. By providing guardians with data-driven reports and real-time notifications of restricted zone violations, the system fosters an “evolving educational ecosystem” where parental oversight is guided by objective telemetric evidence rather than anecdotal observation. Ultimately, the principles of the present disclosure provide a robust, scalable platform that not only mitigates immediate driving risks but also systematically builds the foundational skills required for safe, lifelong driving mastery.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method for monitoring and improving driving behavior of a teen driver, the method comprising:
monitoring, via a computing device, a plurality of driving parameters associated with said teen driver during a driving session;
analyzing said plurality of driving parameters using an artificial intelligence (AI) engine to identify a driving risk;
classifying said driving risk into one of a plurality of risk categories;
generating a real-time corrective feedback notification based on said classified driving risk; and
conveying said real-time corrective feedback notification to said teen driver via an interface of said computing device to mitigate said driving risk.

2. The method as recited in claim 1, wherein said plurality of driving parameters comprises at least one of the following; vehicle speed, braking intensity, turn aggression, and device-based distraction indicators.

3. The method as recited in claim 1, wherein said real-time corrective feedback notification comprises at least one of the following; a haptic alert, an audio cue, and a visual indicator.

4. The method as recited in claim 1 further comprising:
transmitting a parental alert to a secondary computing device associated with a guardian upon an identification of a high-risk driving behavior.

5. The method as recited in claim 1 further comprising:
monitoring a location of said computing device relative to a predefined restricted zone via geo-fencing technology; and
triggering an adaptive safety alert in response to said computing device entering said predefined restricted zone.

6. The method as recited in claim 1 further comprising:
synchronizing said plurality of driving parameters with a cloud-based server to update an adaptive learning model associated with said teen driver.

7. The method as recited in claim 1, wherein said identification of said driving risk is performed at least in part by an Edge Computing Unit (ECU) in wireless communication with said computing device.

8. A computer program product for monitoring and improving driving behavior of a teen driver, the computer program product comprising one or more computer readable storage mediums having program code embodied therewith, the program code comprising programming instructions for:
monitoring, via a computing device, a plurality of driving parameters associated with said teen driver during a driving session;
analyzing said plurality of driving parameters using an artificial intelligence (AI) engine to identify a driving risk;
classifying said driving risk into one of a plurality of risk categories;
generating a real-time corrective feedback notification based on said classified driving risk; and
conveying said real-time corrective feedback notification to said teen driver via an interface of said computing device to mitigate said driving risk.

9. The computer program product as recited in claim 8, wherein said plurality of driving parameters comprises at least one of the following; vehicle speed, braking intensity, turn aggression, and device-based distraction indicators.

10. The computer program product as recited in claim 8, wherein said real-time corrective feedback notification comprises at least one of the following; a haptic alert, an audio cue, and a visual indicator.

11. The computer program product as recited in claim 8, wherein the program code further comprises the programming instructions for:
transmitting a parental alert to a secondary computing device associated with a guardian upon an identification of a high-risk driving behavior.

12. The computer program product as recited in claim 8, wherein the program code further comprises the programming instructions for:
monitoring a location of said computing device relative to a predefined restricted zone via geo-fencing technology; and
triggering an adaptive safety alert in response to said computing device entering said predefined restricted zone.

13. The computer program product as recited in claim 8, wherein the program code further comprises the programming instructions for:
synchronizing said plurality of driving parameters with a cloud-based server to update an adaptive learning model associated with said teen driver.

14. The computer program product as recited in claim 8, wherein said identification of said driving risk is performed at least in part by an Edge Computing Unit (ECU) in wireless communication with said computing device.

15. A computing device, comprising:
a memory for storing a computer program for monitoring and improving driving behavior of a teen driver; and
a processor connected to the memory, wherein the processor is configured to execute program instructions of the computer program comprising:
monitoring a plurality of driving parameters associated with said teen driver during a driving session;
analyzing said plurality of driving parameters using an artificial intelligence (AI) engine to identify a driving risk;
classifying said driving risk into one of a plurality of risk categories;
generating a real-time corrective feedback notification based on said classified driving risk; and
conveying said real-time corrective feedback notification to said teen driver via an interface of said computing device to mitigate said driving risk.

16. The computing device as recited in claim 15, wherein said plurality of driving parameters comprises at least one of the following; vehicle speed, braking intensity, turn aggression, and device-based distraction indicators.

17. The computing device as recited in claim 15, wherein said real-time corrective feedback notification comprises at least one of the following; a haptic alert, an audio cue, and a visual indicator.

18. The computing device as recited in claim 15, wherein the program instructions of the computer program further comprise:
transmitting a parental alert to a secondary computing device associated with a guardian upon an identification of a high-risk driving behavior.

19. The computing device as recited in claim 15, wherein the program instructions of the computer program further comprise:
monitoring a location of said computing device relative to a predefined restricted zone via geo-fencing technology; and
triggering an adaptive safety alert in response to said computing device entering said predefined restricted zone.

20. The computing device as recited in claim 15, wherein the program instructions of the computer program further comprise:
synchronizing said plurality of driving parameters with a cloud-based server to update an adaptive learning model associated with said teen driver.
